(19) United States
(12) Patent Application Publication
(10) Pub. No.: US 2026/0023699 A1
(43) Pub. Date: Jan. 22, 2026

(54) INFORMATION PROCESSING SYSTEM AND METHOD

(71) Applicant: Hitachi Vantara, Ltd., Kanagawa-ken (JP)

(72) Inventors: Junya ISHIDA, Tokyo (JP); Fumiya SHIOTANI, Tokyo (JP)

(21) Appl. No.: 19/076,930

(22) Filed: Mar. 11, 2025

(30) Foreign Application Priority Data
Jul. 22, 2024 (JP) 2024-116842

(51) Int. Cl. G06F 13/20

(52) U.S. Cl. CPC G06F 13/20; G06F 2213/40

(57) ABSTRACT

To propose an information processing system and method capable of suppressing the increase in operational costs. The storage node identifies a storage node including a logical volume as the I/O destination of an I/O request transmitted from a host node and, when that logical volume is placed in another storage node, compresses and transfers the I/O request to the storage node that includes that logical volume. Meanwhile, the storage node detects an availability zone to place the host node as the transmission origin of the I/O request and, when the availability zone to place the detected host node does not match the availability zone to place the storage node, notifies the host node of the storage node placed in the same availability zone as the host node, as the transmission destination of the subsequent I/O requests for the logical volume as the I/O destination.

### CROSS-REFERENCE TO PRIOR APPLICATION

This application relates to and claims the benefit of priority from Japanese Patent Application number 2024-116842, filed on Jul. 22, 2024 the entire disclosure of which is incorporated herein by reference.

### BACKGROUND

The present invention relates to an information processing system and method appropriately applied to an information processing system that transfers user data between availability zones, for example.

In recent years, there has been developed an SDS (Software Defined Storage) that is constructed by installing a storage control software program on general-purpose server devices. Demand for the SDS tends to increase because it does not require dedicated hardware and is highly scalable.

In recent years, there is also a widely used operational system that makes user data redundant by using multiple storage control software programs placed at different locations to improve the availability and reliability of information processing systems.

In the information processing system using this operational system, a storage control software program installed in one site is made active and processes write and read requests (hereinafter collectively referred to as I/O (Input/Output) requests) in user data from the host device while the storage control software programs installed in the remaining sites are made standby.

If an error occurs in the active storage control software program or in a server device in which this storage control software program is installed, the state of any one of the standby storage control software programs is changed to active, and a fail-over is performed so that the storage control software program inherits the I/O processing of the original active storage control software program.

Concerning the information processing systems, U.S. Pat. No. 9,081,610 discloses a technology to manage the migration of applications and user data between a private cloud and a public cloud based on the resource usage rate (server and/or storage usage rate) of the private cloud as a method of improving the yield on investment in a hybrid cloud environment.

[PTL 1] U.S. Pat. No. 9,081,610

### SUMMARY

When the above-described operational system is applied to an information processing system in which multiple storage control software programs are placed in different availability zones, it is preferable to place the active storage control software program and a high-order device in the same availability zone.

The reason is that if the active storage control software program and the high-order device are placed in different availability zones, user data is transferred across availability zones, and such user data transfer across availability zones generates communication costs corresponding to the amount of transferred data and increases operational costs.

However, even if the active storage control software program and the high-order device are initially placed in the same availability zone, a fail-over, if occurred, causes the new active storage control software program and the high-order device to be placed in different availability zones. Consequently, communication costs are generated for subsequent user data transfers between the active storage control software program and the high-order device, increasing operational costs.

The present invention has been made considering the foregoing and proposes an information processing system and method capable of suppressing the increase in operational costs.

To solve the above-described problem, the present invention provides an information processing system including multiple storage nodes placed in different availability zones. The storage node includes a front-end portion that receives an I/O request transmitted from a host node, identifies the storage node including a logical volume as the I/O destination of the received I/O request, and, when the logical volume is placed in the other storage node, transfers the I/O request to the storage node including the logical volume; and an availability zone detection portion that detects the availability zone to place the host node as the transmission origin of the I/O request. The front-end portion compresses and transfers user data to be transferred to the storage node placed in the other availability zone. The availability zone detection portion compares the availability zone to place the detected host node with the availability zone to place the storage node installed with the availability zone detection portion. When the availability zone to place the host node does not match the availability zone where the storage node installed with the availability zone detection portion exists, the availability zone detection portion performs a detection process to notify the host node of the storage node placed in the same availability zone as the host node, as the transmission destination of the subsequent I/O requests for the logical volume as the I/O destination.

The present invention provides an information processing method performed by an information processing system including multiple storage nodes placed in different availability zones. There are provided a first step in which the storage node receives an I/O request transmitted from a host node, identifies the storage node including a logical volume as the I/O destination of the received I/O request, and, when the logical volume is placed in the other storage node, transfers the I/O request to the storage node that includes the logical volume; and a second step in which the storage node detects the availability zone to place the host node as the transmission origin of the I/O request. In the first step, the storage node compresses and transfers user data to be transferred to the storage node placed in the other availability zone. In the second step, the storage node compares the availability zone to place the detected host node with the availability zone to place the storage node and, when the availability zone to place the host node does not match the availability zone to place the storage node, performs a detection process to notify the host node of the storage node placed in the same availability zone as the host node, as the transmission destination of the subsequent I/O requests for the logical volume as the I/O destination.

The present information processing system can prevent user data from being directly transferred to a storage node including the I/O destination logical volume VOL across availability zones or prevent user data read from the I/O destination logical volume VOL in response to an I/O request from being directly transferred to an application across availability zones. The present information processing system can suppress the amount of data transferred between storage nodes across availability zones.

The present invention can embody an information processing system and method capable of suppressing increases in operational costs.

### BRIEF DESCRIPTION OF THE DRAWINGS

FIG. 1 is a block diagram illustrating the overall configuration of an information processing system according to the present embodiment.

FIG. 2 is a block diagram illustrating the schematic configuration of a storage node.

FIG. 3 is a block diagram illustrating the logical configuration of the information processing system.

FIG. 4 is a diagram illustrating the configuration of an I/O path history table.

FIG. 5 is a diagram illustrating the configuration of a front-end portion management table.

FIG. 6 is a diagram illustrating the configuration of a storage node management table.

FIG. 7 is a diagram illustrating the configuration of an application management table.

FIG. 8 is a diagram illustrating the configuration of a logical volume management table.

FIG. 9 is a diagram illustrating the configuration of a storage control portion management table.

FIG. 10 is a flowchart illustrating an I/O process.

FIG. 11A is a flowchart illustrating an availability zone match/mismatch detection process.

FIG. 11B is a flowchart illustrating an availability zone match/mismatch detection process.

FIG. 12 is a diagram illustrating the configuration of a mismatch detection log.

FIG. 13 is a diagram illustrating the configuration of an I/O path correction log.

FIG. 14 is a flowchart illustrating an I/O path correction process.

### DETAILED DESCRIPTION

The description below explains an embodiment of the present invention in detail by referencing the drawings.

### (1) Configuration of the Information Processing System According to the Present Embodiment

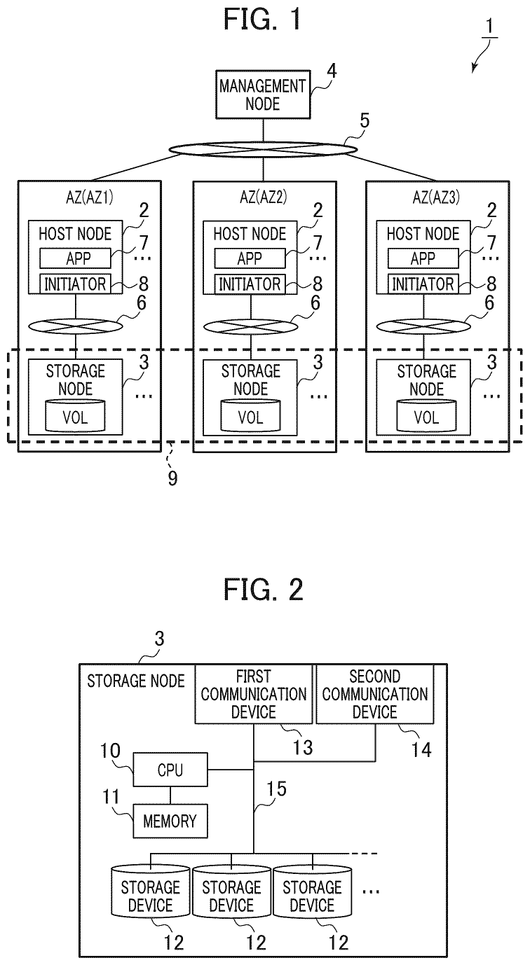

In FIG. 1, reference numeral 1 denotes an information processing system as a whole according to the present embodiment. The information processing system 1 includes one or more host nodes 2 and storage nodes 3 placed in multiple availability zones AZ (AZ1, AZ2, and AZ3), and a management node 4.

Each availability zone AZ and management node 4 are connected via a first network 5 composed of the Internet, Ethernet (registered trademark), or InfiniBand, for example. Each host node 2 and each storage node 3 in the same availability zone AZ are mutually connected via a second network 6 such as Fibre Channel (FC), Ethernet (registered trademark), InfiniBand, or wireless LAN (Local Area Network).

The first and second networks 5 and 6 may be configured as the same network, and each host node 2 and each storage node 3 may be connected to a management network other than the first or second networks 5 and 6.

The host node 2 is a general-purpose computer device that functions as a host (high-order device) for the storage node 3. The host node 2 may be a physically existing computer device or a virtual computer device such as a virtual machine.

An application program (hereinafter simply referred to as application) 7 is installed in the host node 2 and issues I/O requests to the storage node 3 via the first and/or second networks 5 and 6.

The host node 2 includes an iSCSI (Internet SCSI (Small Computer System Interface)) initiator (hereinafter simply referred to as initiator) 8 compliant with ALUA (Asymmetric Logical Unit Access). The initiator 8 prioritizes the multiple paths, if any, to a logical volume VOL (FIG. 1), described later, generated in the storage node 3, and transmits the I/O request issued by the application 7 to that logical volume VOL using the highest-priority path.

The storage node 3 is a general-purpose physical server device that provides the host node 2 with a logical volume VOL for reading and writing data. As illustrated in FIG. 2, the storage node 3 includes one or more CPUs (Central Processing Units) 10, memory 11, multiple storage devices 12, and one or more first and second communication devices 13 and 14. The CPU 10 is connected to the storage devices 12 and the first and second communication devices 13 and 14 via an internal network 15.

The CPU 10 is a processor that controls the operations of the entire storage node 3. The memory 11 is composed of volatile semiconductor memory such as SRAM (Static RAM (Random Access Memory)) or DRAM (Dynamic RAM), and is used as the working memory of the CPU 10 to temporarily store various programs and necessary data. At least one or more CPUs 10 execute the programs stored in the memory 11, thereby performing various processes of the entire storage node 3 as described later.

The storage device 12 is composed of a large-capacity non-volatile storage device such as an NVMe (Non-Volatile Memory) drive, a SAS (Serial Attached SCSI) drive, a SATA (Serial ATA (Advanced Technology Attachment)), an SSD (Solid State Drive) or an SCM (Storage Class Memory) and provides a physical storage area to actually store the user data stored in the logical volume VOL.

The first communication device 13 is an interface for the storage node 3 to communicate with the management node 4 or storage nodes 3 placed in other availability zones AZ via the first network 5 and is composed of a NIC (Network Interface Card), for example. The first communication device 13 performs protocol control during communication with the management node 4 or storage nodes 3 placed in other availability zones AZ.

The second communication device 14 is an interface for the storage node 3 to communicate with the host node 2 or other storage nodes 3 placed in the same availability zone AZ via the second network 6 and is composed of a NIC, an FC card, or a wireless LAN card, for example. The second communication device 14 performs protocol control during communication with the host node 2 or other storage nodes 3 placed in the same availability zone AZ.

According to the present embodiment, as illustrated in FIG. 1, each storage node 3 is organized into a group called cluster 9 along with other storage nodes 3 placed in each availability zone AZ and is managed on a cluster basis. In the example of FIG. 1, only one cluster 9 is configured, but multiple clusters 9 may be configured in the system.

The management node 4 is a computer device that manages the IP address on the first network 5 of the initiator 8 running on the host node 2 placed in each availability zone AZ corresponding to the availability zone AZ where the host node 2 is placed.

As described later, the storage node 3 may inquire about the availability zone AZ placing the host node 2 assigned with the specified IP address, and then the management node 4 responds to the storage node 3 with the availability zone AZ placing that host node 2.

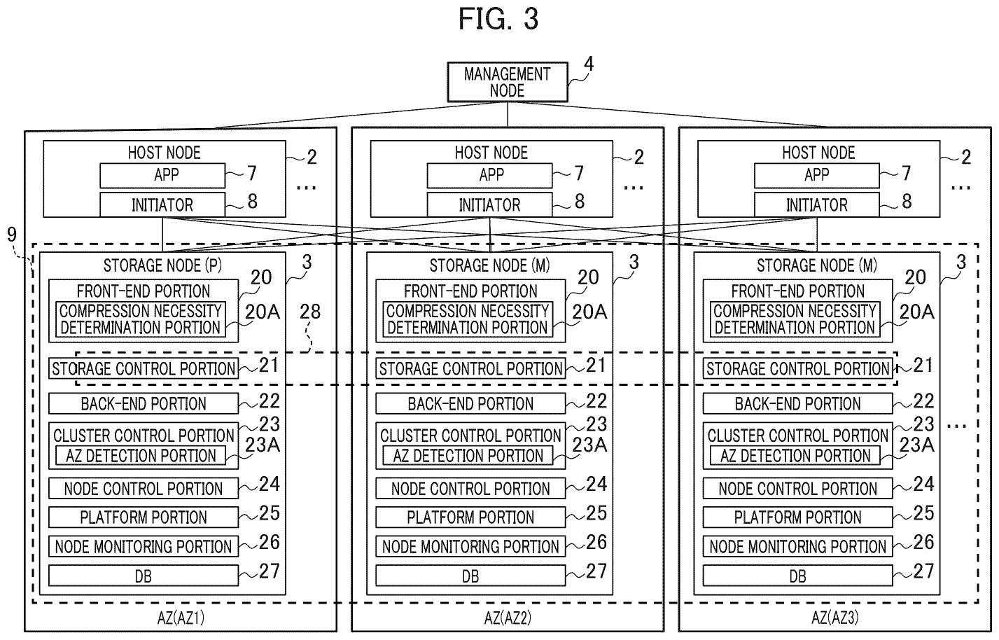

FIG. 3 illustrates the logical configuration of the information processing system 1 according to the present embodiment. As illustrated in FIG. 3, the host node 2 placed in each availability zone AZ is connected to all storage nodes 3 placed in the availability zones AZ via the first and second networks 5 and 6.

As described above, the host node 2 is installed with the application 7 and the initiator 8. As needed, the application 7 transmits an I/O request to any of the storage nodes 3 via the initiator 8 and the path selected by the initiator 8 while the I/O request specifies a logical volume as the I/O destination (hereinafter referred to as an I/O destination logical volume) VOL and an I/O destination address in that I/O destination logical volume VOL.

Each storage node 3 includes a front-end portion 20, one or more storage control portions 21, a back-end portion 22, a cluster control portion 23, a node control portion 24, a platform portion 25, a node monitoring portion 26, and a database 27. In the following description, the storage node 3 to place the front-end portion 20, the storage control portion 21, the back-end portion 22, the cluster control portion 23, the node control portion 24, the platform portion 25, and the node monitoring portion 26 is referred to as the own storage node 3.

The front-end portion 20 is a software program having the function of distributing an I/O request supplied from the application 7 in any of the host nodes 2 to the storage control portion 21 in the own storage node 3 to process the I/O request or to another storage node 3 placing the storage control portion 21 to process the I/O request.

Practically, in the information processing system 1 according to the present embodiment, each logical volume VOL is generated corresponding to the storage control portion 21 (more precisely a redundant group 28 described later), and the storage control portion 21 (more precisely a redundant group 28 described later) corresponding to the logical volume VOL reads and writes user data from and to that logical volume VOL.

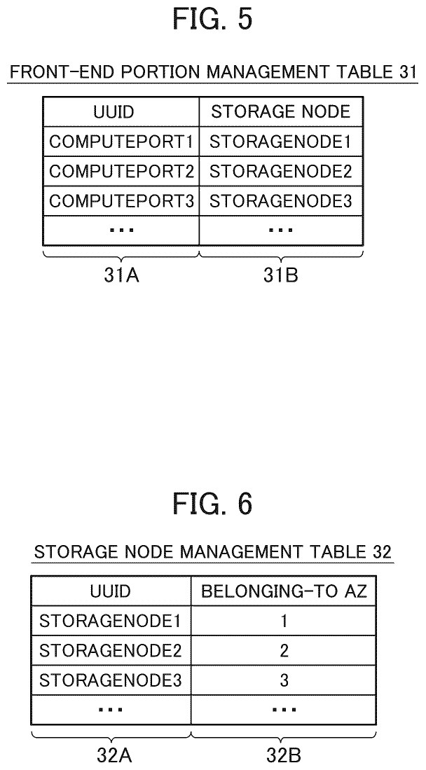

The front-end portion 20 receives an I/O request, identifies the I/O destination logical volume VOL from the I/O request, references management information stored in the database 27 (described later by referencing FIGS. 5 through 9), and identifies the storage control portion 21 corresponding to the I/O destination logical volume VOL and the storage node 3 to place the storage control portion 21.

When the identified storage control portion 21 is placed in the own storage node 3, the front-end portion 20 transfers the I/O request to the storage control portion 21. When the storage control portion 21 corresponds to the storage control portion 21 in another storage node 3, the front-end portion 20 transfers (dispatches) the I/O request to the front-end portion 20 in that storage node 3.

The storage control portion 21 is software (storage control software program) that functions as a controller for SDS (Software Defined Storage). The storage control portion 21 accepts the I/O request from the front-end portion 20 and issues an I/O command corresponding to the accepted I/O request to the back-end portion 22.

According to the present embodiment, each storage control portion 21 installed in the storage node is managed as a group that configures a redundant configuration along with other storage control portions 21 installed in other storage nodes 3 placed in other availability zones AZ. This group is hereinafter referred to as a redundant group 28.

FIG. 3 illustrates a case in which one redundant group 28 is configured by three storage control portions 21 placed in the storage nodes 3 placed in different availability zones AZ, and the following description assumes that the redundant group 28 is configured similarly. The redundant group 28 may be formed by two or four or more storage control portions 21 depending on the number of availability zones AZ.

The redundant group 28 is set to a state in which one storage control portion 21 can accept I/O requests from the host node 2 (active state, hereinafter referred to as active mode) and the other storage control portions 21 do not accept I/O requests from the host node 2 (standby state, hereinafter referred to as passive mode).

When an error occurs in the storage control portion 21 set to active mode (hereinafter referred to as the active storage control portion as appropriate) or in the storage node 3 to place the active storage control portion 21, the redundant group 28 changes the state of the storage control portion 21 hitherto set to passive mode (hereinafter referred to as the passive storage control portion as appropriate) to active mode.

If the active storage control portion 21 cannot operate, the I/O process performed by the active storage control portion 21 can be inherited by the passive storage control portion 21 that configures the same redundant group 28 (fail-over function).

For this purpose, each storage node 3 maintains configuration information (unshown) on the redundant group 28 as management information, as to which storage control portions 21 configure the redundant group 28 and which of the storage control portions 21 configuring the redundant group 28 is active. When transferring an I/O request, the front-end portion 20 references this management information and transfers the I/O request to the active storage control portion 21 out of the storage control portions 21 configuring the corresponding redundant group 28.

The back-end portion 22 is a software program that functions as the back end of I/O processes in the storage node 3. The back-end portion 22 allocates a physical storage area provided by the storage device 12 (FIG. 2) in the own storage node 3 and/or a physical storage area provided by the storage device 12 in another storage node 3 in the same availability zone AZ, to the logical volume VOL corresponding to the redundant group 28 configured by the active storage control portion 21 placed in the own storage node 3.

Based on the above-described 1/0 command supplied from the active storage control portion 21, the back-end portion 22 writes user data to a storage area assigned to the logical volume VOL corresponding to the active storage control portion 21 or reads the written user data from the storage area and transfers it to the storage control portion (active storage control portion) 21 that transmitted the I/O command. The user data read from the storage region and transferred to the storage control portion 21 is then transferred as read data to the host node 2 that transmitted the I/O request via the storage control portion 21 and the front-end portion 20 in sequence.

The cluster control portion 23 is a software program having the function of performing control processes on the entire cluster 9 (hereinafter referred to as the own cluster) to which the own storage node 3 belongs or performing control processes on scale-out of the cluster 9. In the information processing system 1 according to the present embodiment, the state of one of the cluster control portions 23 installed in the storage nodes 3 in the cluster 9 is set to primary mode, and only the cluster control portion 23 set to primary mode (hereinafter referred to as the primary cluster control portion) performs various control processes while maintaining the consistency of the entire cluster 9. For example, the primary cluster control portion 23 configures the above-described redundant group 28 in the cluster 9 in response to a request from the management node 4, and registers and manages the configured redundant group 28 in a redundant group management table (unshown).

The cluster control portions 23 other than the primary cluster control portion 23 are set to master mode or secondary mode against an error on the primary cluster control portion 23.

The master mode is an operation mode that maintains the standby state activated to immediately inherit the process hitherto performed by the primary cluster control portion 23 when an error occurs on the primary cluster control portion 23 or the storage node 3 installed with the primary cluster control portion 23. At least one master-mode cluster control portion (hereinafter referred to as a master cluster control portion) 23 is placed in each availability zone AZ.

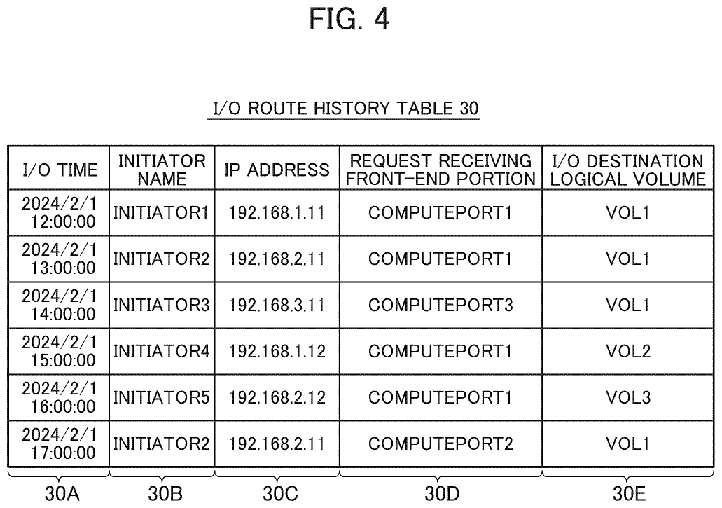

To immediately inherit the process performed by the primary cluster control portion 23, the master cluster control portion 23 stores and maintains, in the database 27, management information with the same contents as all the management information (information such as that stored in tables described later using FIGS. 4 through 9) stored and managed by the primary cluster control portion 23 in the database 27.

When the management information maintained by the primary cluster control portion 23 is updated, the primary cluster control portion 23 supplies all master cluster control portions 23 with the difference before and after the update as difference data via the first or second network 5 or 6 and, based on the difference data, the master cluster control portion 23 updates the management information maintained by the master cluster control portion 23 similar to the management information maintained by the primary cluster control portion 23.

Since the master cluster control portion 23 always maintains the same management information as that of the primary cluster control portion 23, even if an error occurs on the primary cluster control portion 23, for example, and the state of the cluster control portion 23 hitherto set to master mode is changed to primary mode, the cluster control portion 23 that is newly changed to primary mode can inherit the control process hitherto performed by the original primary cluster control portion 23.

To prevent a situation in which two or more primary cluster control portions 23 exist, three or more cluster control portions 23 are operated, and one of the operated cluster control portions 23 is selected by majority vote and is set to the primary cluster control portion 23. The state of the remaining operated cluster control portions 23 is set to master mode.

The secondary mode is an operation mode that performs no control processes on the entire cluster 9. When the number of cluster control portions 23 set to master mode in the same cluster 9 falls below a predetermined threshold, the state of any cluster control portion 23 set to secondary mode is changed to master mode.

The secondary-mode cluster control portion 23 also stores and maintains, in the database 27, management information with the same contents as all the management information stored and managed in the database 27 by the master cluster control portion 23 in the same availability zone AZ.

When the management information maintained by the same master cluster control portion 23 is updated, the master cluster control portion 23 supplies all secondary-mode cluster control portions 23 with the difference before and after the update as difference data via the second network 6 and, based on the difference data, the cluster control portion 23 updates the management information maintained by the cluster control portion 23 similar to the management information maintained by the master cluster control portion 23.

The node control portion 24 is a software program having the function of performing various control processes to be completed within the own storage node 3 in response to a request from the primary cluster control portion 23. Practically, to avoid load concentration on itself, the primary cluster control portion 23 requests the node control portion 24 in each storage node 3 to perform processes to be completed within each storage node 3. When supplied with the request, the node control portion 24 performs control processes on the front-end portion 20, the storage control portion 21, and/or the back-end portion 22 in the own storage node 3 based on the request.

The platform portion 25 is a software program that controls the start-up and termination of each software program in the own storage node 3. For example, the platform portion 25 starts each software program such as the front-end portion 20 when the storage node 3 starts, and meanwhile, terminates the operation of each software program such as the front-end portion 20 when the operation of the storage node 3 terminates.

The node monitoring portion 26 is a software program having the function of monitoring the feasibility of the storage node 3 in the same availability zone AZ. Practically, in each availability zone AZ, the node monitoring portion 26 in the storage node 3 to place the primary cluster control portion 23 or the master-mode cluster control portion 23 exchanges heartbeat signals with other storage nodes 3 in the same availability zone AZ and determines the feasibility of the corresponding storage node 3 based on whether a heartbeat signal is received.

When the node monitoring portion 26 detects an error on the storage node 3, the result is notified to the primary cluster control portion 23. Then, the primary cluster control portion 23 blocks the storage node 3 and, if necessary, supplies the cluster control portion 23 of the corresponding storage node 3 with an instruction to perform a fail-over.

### (2) Data Compression-Transfer Function and I/O Request Destination Correction Function of Present Embodiment

The description below explains the data compression-transfer function installed in the front-end portion 20 and the I/O request destination correction function installed in the cluster control portion 23 of the storage node 3 according to the present embodiment.

The data compression function compresses and transfers user data as necessary when user data is transferred to storage nodes 3 belonging to different availability zones AZ. When the host node 2 (more specifically, the application 7) hitherto issues I/O requests using any logical volume VOL in the own cluster 9 as the I/O destination logical volume VOL, the I/O request destination correction function allows that host node 2 to change the destination of subsequent I/O requests targeted at that logical volume VOL to any storage node 3 that belongs to (or is placed in) the same availability zone AZ as the host node 2 (more specifically, the application 7).

Practically, the information processing system 1 according to the present embodiment enables the user to provide each logical volume VOL with a key focus on costs or I/O performance during I/O processes on the logical volume VOL.

The “cost” here signifies the communication fee generated according to the amount of data transferred across availability zones AZ. When “cost” is set as the key focus on a logical volume VOL and user data written to or read from that logical volume VOL is transferred to the storage node 3 placed in another availability zone AZ, the front-end portion 20 compresses and transfers the user data to reduce the communication cost between availability zones AZ.

The “I/O performance” here signifies the I/O process performance viewed from the application 7 that issued an I/O request. When user data is compressed and transferred, the data compression process requires a proportionate amount of time. When “I/O performance” is the key focus on a logical volume VOL, the front-end portion 20 transfers user data written to or read from that logical volume VOL between availability zones AZ without compression.

The information about an I/O request hitherto received by the storage nodes 3 in the same cluster 9 includes, as acquired from the I/O request, the initiator name and the IP address on the first network 5 of the initiator 8 as the transmission origin; and the front-end portion 20 having received the I/O request and the I/O destination logical volume VOL for the I/O request while the primary cluster control portion 23 collects these pieces of information as I/O path information from the storage nodes 3 and manages it.

Based on the collected I/O path information and each I/O request, the primary cluster control portion 23 inquires of the management node 4 about the availability zone AZ (more specifically, the availability zone AZ including the application 7 installed in the host node 2; the same applies hereinafter) to place the host node 2 having issued the I/O request and determines whether the acquired availability zone AZ to place the host node 2 matches the availability zone AZ to place the storage node 3 including the I/O destination logical volume VOL for the I/O request.

If these availability zones AZ do not match and “cost” is set as the key focus on the I/O destination logical volume VOL, the primary cluster control portion 23 notifies the host node 2 (more specifically, the application 7) of the front-end portion 20 in any storage node 3 belonging to the same availability zone AZ as the host node 2 (more specifically, the application 7), as the transmission destination for subsequent I/O requests targeting at the same logical volume VOL.

The host node 2 (more specifically, the application 7) then changes the setting of the initiator 8 so that the notified front-end portion 20 serves as the transmission destination of the I/O requests targeted at the logical volume VOL. When receiving the I/O request as a write request, the front-end portion 20 compresses the user data, as the write target, supplied along with the write request and transfers the user data to the front-end portion 20 in the storage node 3 including the I/O destination logical volume VOL for the I/O request.

When receiving the 1/0 request as a read request, the front-end portion 20 of the storage node 3 including the I/O destination logical volume VOL compresses the user data read from the I/O destination logical volume VOL and transfers the user data to the storage node 3 as the transfer origin of the I/O request (the storage node 3 placed in the same availability zone AZ as the application 7 that issued the I/O request).

The information processing system 1 suppresses the amount of user data transferred between availability zones AZ when “cost” is the key focus on the I/O destination logical volume VOL. It is possible to suppress the communication fee generated according to the amount of data transferred.

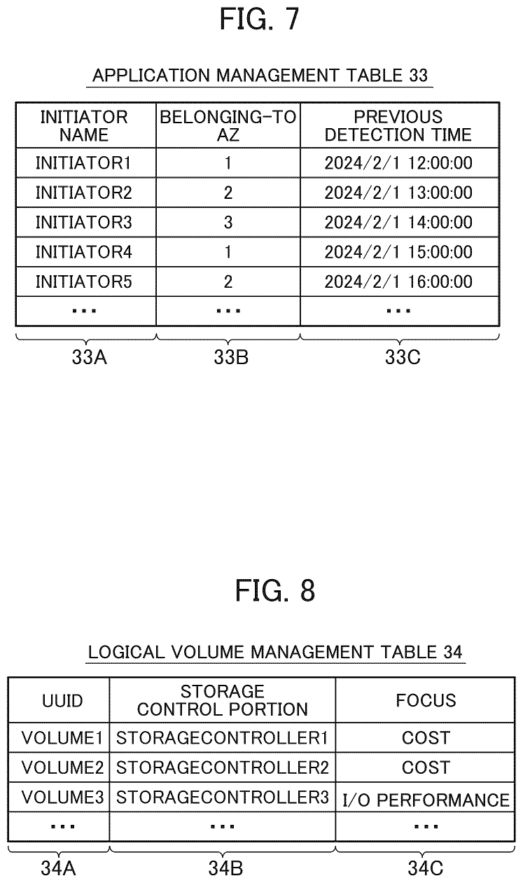

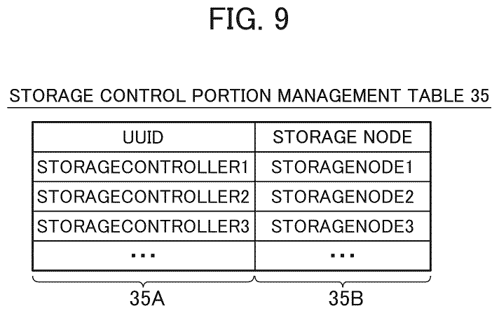

The cluster control portion 23 of each storage node 3 includes an availability zone detection portion 23A and the front-end portion 20 includes a compression necessity determination portion 20A as the means for embodying the data compression-transfer function and the I/O request destination correction function of the present embodiment as described above. The database 27 of the storage node 3 stores, as part of the management information, an I/O path history table illustrated in FIG. 4, a front-end portion management table illustrated in FIG. 5, a storage node management table illustrated in FIG. 6, an application management table illustrated in FIG. 7, a logical volume management table illustrated in FIG. 8, and a storage control portion management table illustrated in FIG. 9.

The availability zone detection portion 23A is a functional portion having the function of inquiring of the management node 4 about the availability zone AZ including the application 7 based on the IP address of the application 7 as the transmission origin, included in the I/O request received by each storage node 3 in the own cluster 9.

The compression necessity determination portion 20A is a functional portion having the function of determining whether to compress the user data to be transferred between availability zones AZ as described above. The compression necessity determination portion 20A performs the determination by confirming the key focus on the logical volume VOL where the user data to be transferred is read and written.

An I/O path history table 30 is used to manage the I/O requests hitherto received by each front-end portion 20 installed in each storage node 3 in the cluster 9 to which the storage node 3 maintaining the I/O path history table 30 belongs.

According to the present embodiment, when the front-end portion 20 in the own storage node 3 receives an I/O request, the cluster control portion 23 notifies the primary cluster control portion 23 of the initiator name and IP address of the initiator 8 that issued the I/O request, the UUID (Universally Unique Identifier) of the front-end portion 20 that received the I/O request, and the UUID of the I/O destination logical volume VOL for the I/O request directly or via the master cluster control portion 23 in the own availability zone AZ.

The primary cluster control portion 23 uses the I/O path history table 30 to register and manage these pieces of information notified from the master cluster control portions 23 in other availability zones AZ and similar information on I/O requests received by the front-end portion 20 in the own storage node 3.

As illustrated in FIG. 4, the I/O path history table 30 includes an I/O time column 30A, an initiator name column 30B, an IP address column 30C, a request receiving front-end portion column 30D, and an I/O destination logical volume column 30E. In the I/O path history table 30, one record (row) corresponds to one I/O request received by one front-end portion 20 in the same cluster 9.

The I/O time column 30A stores the date and time when the corresponding storage node 3 received the corresponding I/O request. The initiator name column 30B stores the identifier (initiator name) of the initiator 8 used by the application 7 that is the transmission origin of the I/O request and is recognized based on the I/O request, and the IP address column 30C stores the IP address of the initiator 8 that is recognized based on the I/O request. In the description below, the IP address of the initiator 8 may signify the IP address of the application 7 that uses the initiator 8.

The request receiving front-end portion column 30D stores a UUID (Universally Unique Identifier) uniquely given to the front-end portion 20 that received the I/O request. The I/O destination logical volume column 30E stores a UUID uniquely given to the I/O destination logical volume VOL for the I/O request.

The example in FIG. 4 shows that the front-end portion 20 with the UUID of “computeport1” received, on “2024 Feb. 1 12:00:00,” an I/O request for the logical volume that is given the UUID of “volume1” as the I/O destination logical volume VOL and was transmitted from the initiator 8 (more precisely, the application 7 using the initiator 8) with the initiator name of “initiator1” having the IP address of “192.168.1.11.”

The front-end portion management table 31 is used to manage the front-end portion 20 placed in each storage node 3 existing in the same cluster 9 and includes a UUID column 31A and a storage node column 31B. In the front-end portion management table 31, one record corresponds to one front-end portion 20 existing in the same cluster 9.

The UUID column 31A stores the UUID of the corresponding front-end portion 20, and the storage node column 31B stores the UUID of the storage node 3 to place the front-end portion 20.

The example in FIG. 5 shows that the front-end portion 20 with the UUID of “computeport1” is placed in the storage node 3 with the storage node UUID of “StorageNode1.”

The storage node management table 32 is used to manage the availability zone AZ to which each storage node 3 existing in the same cluster 9 belongs (is placed), and includes a UUID column 32A and a belonging-to availability zone column 32B as illustrated in FIG. 6. In the storage node management table 32, one record corresponds to one storage node 3.

The UUID column 32A stores the UUID of the corresponding storage node 3, and the belonging-to availability zone column AZ stores the identification number (hereinafter referred to as the availability zone number) of the availability zone AZ to which the storage node 3 belongs (is placed).

The example in FIG. 6 shows that the storage node 3 with the UUID of “StorageNode1” belongs to (is placed in) the availability zone AZ with the availability zone number of “1.”

An application management table 33 is used to manage the applications 7 installed in each host node 2 in the same cluster 9 and includes an initiator name column 33A, a belonging-to availability zone column 33B, and a previous detection time column 33C as illustrated in FIG. 7. In the application management table 33, one record corresponds to one the application 7.

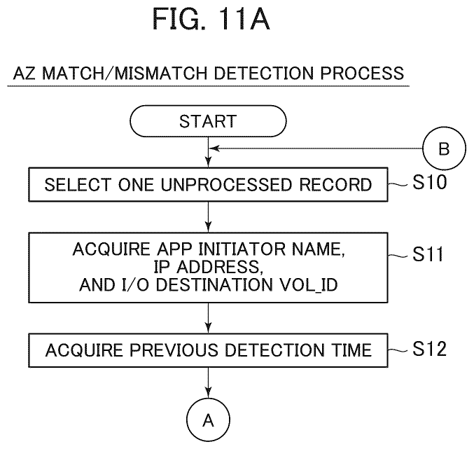

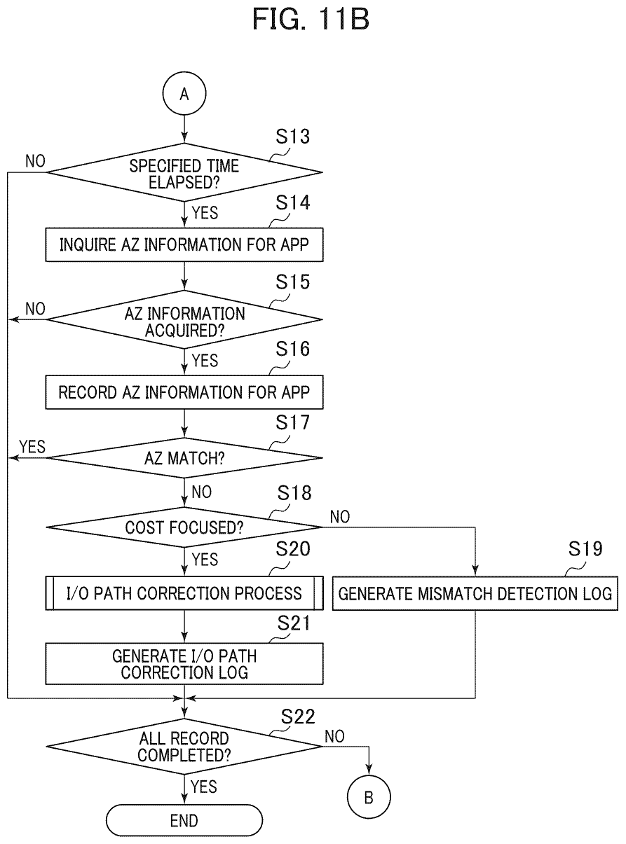

The initiator name column 33A stores the initiator name of the initiator 8 used by the corresponding application 7, and the belonging-to availability zone column 33B stores the identification number of the availability zone AZ (more precisely, the availability zone AZ to which the host node 2 installed with the application 7 belongs) where the application 7 exists. The previous detection time column 33C stores the date and time when an availability zone match/mismatch detection process (described later in FIG. 11A and FIG. 11B) was last performed on the application 7.

The example in FIG. 7 shows that the application 7 using the initiator 8 with the initiator name of “initiator1” is installed in the host node 2 belonging to (is placed in) the availability zone AZ with the identification number of “1,” and the date and time when the availability zone match/mismatch detection process was last performed is “2024 Feb. 1 12:00:00.”

The logical volume management table 34 is used to manage logical volumes VOL existing in the same cluster 9 and includes a UUID column 34A, a storage control portion column 34B, and a key focus column 34C as illustrated in FIG. 8. In the logical volume management table 34, one record corresponds to one logical volume VOL existing in the same cluster 9.

The UUID column 34A stores the UUID uniquely given to the corresponding logical volume VOL, and the storage control portion column 34B stores the UUID of the storage control portion 3 corresponding to the logical volume VOL.

The key focus column 34C stores information (information indicating the key focus) indicating whether costs or I/O performance is to be focused when an I/O process is performed on the logical volume VOL. This setting is provided by the user in advance. The example in FIG. 8 shows that the key focus column 34C stores “cost” to focus on costs and “I/O performance” to focus on the I/O performance.

As above, user data read from and written to a logical volume VOL with the key focus set to “cost” is compressed and transferred between availability zones AZ, while user data read from and written to a logical volume VOL with the key focus set to “I/O performance” is transferred between availability zones AZ without compression.

The example in FIG. 8 shows that the logical volume VOL with the UUID of “Volume1” focuses on “cost,” and the storage control portion 21 with the UUID of “StorageController1” is scheduled to perform the I/O process.

The storage control portion management table 35 is used to manage the storage control portion 21 placed in each storage node 3 existing in the same cluster 9 and includes a UUID column 35A and a storage node column 35B as illustrated in FIG. 9. In the storage control portion management table 35, one record corresponds to one storage control portion 21 existing in the same cluster 9.

The UUID column 35A stores a UUID uniquely given to the corresponding storage control portion 21, and the storage node column 35B stores the UUID of the storage node 3 to which the storage control portion 21 belongs (is placed).

The example in FIG. 9 shows that the storage control portion 21 with the UUID of “StorageController1” belongs to (is placed in) the storage node 3 with the UUID of “StorageNode1.”

### (3) Various Processes Performed Concerning Function of Present Embodiment

The description below explains the contents of various processes performed in each storage node 3 concerning the data compression-transfer function and the I/O request destination correction function according to the present embodiment. While the following description assumes the software program (functional portion) to perform various processes, the CPU 10 (FIG. 2) of the storage node 3 practically performs the processes based on the software program.

### (3-1) I/O Process

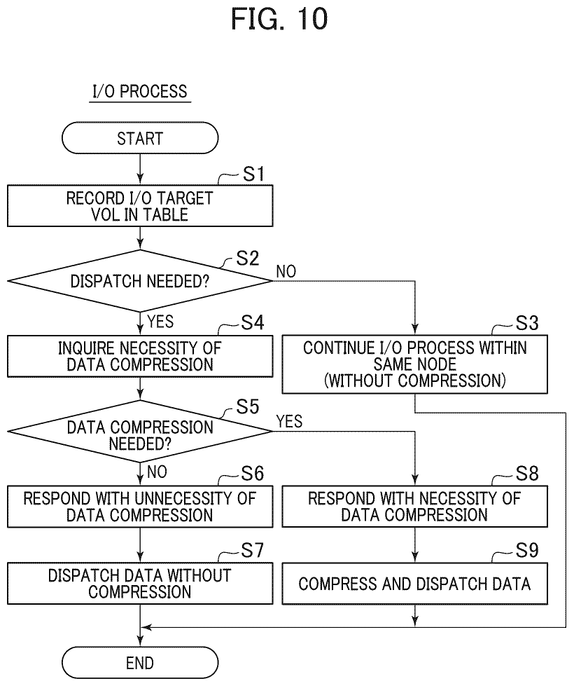

FIG. 10 illustrates the flow of an I/O process performed by the front-end portion 20 in the storage node 3 that receives an I/O request from the application 7. When the front-end portion 20 receives an I/O request, the I/O process illustrated in FIG. 10 starts.

The front-end portion (hereinafter referred to as the request receiving front-end portion) 20 performs a process to record the necessary information on the I/O request in the I/O path history table 30 (FIG. 4) maintained by each storage node 3 in the same cluster 9 (S1).

Specifically, from the I/O request, the front-end portion 20 extracts the initiator name of the initiator 8 used by the application 7 having transmitted the I/O request, the IP address of the initiator 8, and the UUID of the I/O destination logical volume for the I/O request.

The front-end portion 20 transmits, as the I/O path history information, the extracted information and the I/O request reception date and time to the front-end portion 20 of the storage node (hereinafter referred to as the primary storage node) 3 placing the primary cluster control portion 23 directly (for master mode assigned to the cluster control portion 23 of the storage node 3 placing the front-end portion 20) or via the master-mode cluster control portion 23 in the same availability zone AZ (for secondary mode assigned to the cluster control portion 23 of the storage node 3 placing the front-end portion 20).

The master front-end portion 20 of the primary storage node 3 receives this I/O path history information and registers it in the I/O path history table 30. The front-end portion 20 transfers the I/O path history information registered in the I/O path history table 30 to the storage node (hereinafter referred to as the master storage node) 3 placing the master cluster control portion 23 in each availability zone AZ or to each of the front-end portions 20 of other storage nodes 3 via the master storage node 3.

The front-end portion 20 having received the I/O path history information in the master storage node 3 or other storage nodes 3 uses its own I/O path history table 30 to record the I/O path history information. As above, the I/O path history information is recorded in the I/O path history table 30 maintained by each storage node 3 in the cluster 9.

The request receiving front-end portion 20 determines whether the received I/O request needs to be transferred (dispatched) to other storage nodes 3 (S2).

Specifically, the request receiving front-end portion 20 identifies a record that is included in the logical volume management table 34 (FIG. 8) and corresponds to the UUID column 34A storing the UUID of the I/O destination logical volume VOL extracted from the I/O request at step S1, thus acquiring the UUID of the storage control portion 21 stored in the storage control portion column 34B of that record.

The request receiving front-end portion 20 identifies a record that is included in the storage control portion management table 35 (FIG. 9) and corresponds to the UUID column 35A storing the UUID of the storage control portion 21 acquired as above from the logical volume management table 34, thus acquiring the UUID of the storage node 3 stored in the storage node column 35B of that record.

The request receiving front-end portion 20 identifies a record that is included in the storage node management table 32 (FIG. 6) and corresponds to the UUID column 32A storing the UUID of the storage node 3 acquired as above from the storage control portion management table 35, thus acquiring the availability zone number of the availability zone AZ stored in the belonging-to availability zone column 32B of that record.

The request receiving front-end portion 20 determines whether the acquired identification number matches the availability zone number of the availability zone AZ to which the own storage node 3 belongs (is placed), thereby determining whether the received I/O request needs to be transferred (dispatched) to other storage nodes 3.

A negative result from this determination signifies that the I/O destination logical volume VOL is included in its own storage node 3, and therefore the received I/O request need not be transferred (dispatched) to other storage nodes 3.

At this time, the request receiving front-end portion 20 transfers the I/O request to the storage control portion 21 in the own storage node 3 corresponding to the 1/0 destination logical volume VOL in the same storage node 3 (S3). When the I/O request is a write request, the request receiving front-end portion 20 also transfers the user data as a write target, transmitted from the application 7 along with the write request, to the storage control portion 21 without compression. Then, the request receiving front-end portion 20 terminates this I/O process.

The storage control portion 21 receives this I/O request and performs the I/O process on the I/O destination logical volume VOL according to the I/O request.

A positive result from the determination at step S2 signifies that the I/O destination logical volume VOL is placed in another storage node 3, and therefore the received I/O request needs to be transferred (dispatched) to that storage node 3.

The request receiving front-end portion 20 transfers the I/O request as a write request and associated data to the storage node 3 provided with the I/O destination logical volume VOL by inquiring of the compression necessity determination portion 20A (FIG. 3) about whether the user data needs to be compressed (S4).

The compression necessity determination portion 20A accepts the inquiry, references the logical volume management table 34 (FIG. 8), and determines whether the user data needs to be compressed (S5). This determination is performed by referencing the logical volume management table 34 and determining whether the key focus on the I/O destination logical volume VOL is “cost” and whether the I/O destination logical volume VOL exists in an availability zone AZ other than the availability zone AZ to which the own storage node 3 belongs (is placed).

If the result from this determination is negative, the compression necessity determination portion 20A responds to the request receiving front-end portion 20 that data compression is unnecessary (S5). Even when the I/O request is a write request, the request receiving front-end portion 20 receives this response and transfers the user data as a write target without compression to the front-end portion 20 of the storage node 3 placing the active storage control portion 21 corresponding to the I/O destination logical volume VOL for the user data (S7). Then, the request receiving front-end portion 20 terminates this I/O process.

If the result from the determination at step S5 is positive, the compression necessity determination portion 20A responds to the request receiving front-end portion 20 that data compression is necessary (S8). When the I/O request is a write request, the request receiving front-end portion 20 receives this response, compresses the user data as a write target, and transfers the resulting compressed data to the front-end portion 20 of the storage node 3 placing the active storage control portion 21 corresponding to the I/O destination logical volume VOL for the user data (S9). Then, the request receiving front-end portion 20 terminates this I/O process.

### (3-2) Availability Zone Match/Mismatch Detection Process

FIGS. 11A and 11B illustrate the availability zone match/mismatch detection process performed by the availability zone detection portion 23A of the primary cluster control portion 23 asynchronously with the I/O process at regular intervals.

Based on the procedure illustrated in FIGS. 11A and 11B, the availability zone detection portion 23A notifies each application 7, having hitherto issued an I/O request targeted at any logical volume VOL in the cluster 9, of any storage node 3, belonging to (placed in) the same availability zone AZ as the application 7, as the transmission destination of the subsequent I/O requests targeted at that logical volume VOL.

Practically, the availability zone detection portion 23A starts this availability zone match/mismatch detection process to select one of the records that are included in the I/O path history table 30 (FIG. 4) and remain unprocessed at step S11 and later (S10).

From the record selected at step S10, the availability zone detection portion 23A acquires the initiator name of the initiator 8 that transmitted the corresponding I/O request, the IP address of the initiator 8 on the first network 5, and the UUID of the I/O destination logical volume VOL for that I/O request (S11).

From the application management table 33 (FIG. 7), the availability zone detection portion 23A acquires the time (hereinafter referred to as the previous detection time) when the application 7 (hereinafter referred to as the target application), having issued the corresponding I/O request via the initiator 8 whose initiator name is acquired at step S11, last performed the process at steps S11 through S21 (S12).

Specifically, the availability zone detection portion 23A identifies a record whose initiator name column 33A in the application management table 33 stores the initiator name acquired at step S11, and acquires the time stored in the previous detection time column 33C of that record as the previous detection time of the target application.

The availability zone detection portion 23A determines whether a predetermined time has elapsed from the previous detection time acquired at step S12 to the present (S13). This determination is performed to prevent the process at step S14 and later from being frequently performed, which negatively affects the I/O process. If the result from this determination is negative, the availability zone detection portion 23A proceeds to step S22.

If the result from the determination at step S13 is positive, the availability zone detection portion 23A inquires of the management node 4 about the availability zone AZ where the target application 7 exists (S14). The availability zone detection portion 23A then determines whether the inquiry at step S14 acquires the information on the availability zone AZ where the target application 7 exists (S15).

If the result from this determination is negative, the availability zone detection portion 23A proceeds to step S22. A negative result acquired at step S15 includes a case where the communication with the management node 4 fails due to a configuration error or a network failure, for example.

If the result from the determination at step $15 is positive, the availability zone detection portion 23A stores the initiator name of the initiator 8 used by the target application 7 acquired at step S11, the availability zone number of the availability zone AZ where the target application 7 exists, and the current time in the initiator name column 33A, the belonging-to availability zone column 33B, or the previous detection time column 33C of the application management table 33 to be newly written or overwritten (S16).

The availability zone detection portion 23A determines whether the availability zone AZ where the target application 7 exists matches the availability zone AZ of the storage node 3 that received the I/O request from the target application 7 (S17).

Specifically, the availability zone detection portion 23A references the I/O path history table 30 and acquires the UUID of the front-end portion 20 to which the latest I/O request of the target application 7 is transmitted. The availability zone detection portion 23A acquires the UUID of the storage node 3, placing the front-end portion 20 assigned with the acquired UUID, from the front-end portion management table 31 (FIG. 5).

The availability zone detection portion 23A acquires the availability zone number of the availability zone AZ, placing the storage node 3 assigned with the acquired UUID, from the storage node management table 32 (FIG. 6).

The availability zone detection portion 23A acquires the availability zone number of the availability zone AZ, where the target application 7 exists, from the application management table 33 (FIG. 7).

The availability zone detection portion 23A compares the acquired availability zone number of the availability zone AZ where the target application 7 exists with the availability zone number of the availability zone AZ of the storage node 3 that received the I/O request from the target application 7, and determines whether they match (S17).

If the result from this determination is positive, the availability zone detection portion 23A proceeds to step S22. If the result from the determination at step S17 is negative, the availability zone detection portion 23A determines whether the I/O-targeted logical volume VOL is cost-focused (S18). This determination is performed by determining whether the logical volume management table 34 (FIG. 8) stores “cost” in the key focus column 34C for the record corresponding to the I/O-targeted logical volume VOL.

If the result from this determination is negative, the availability zone portion detection 23A generates a log (hereinafter referred to as a mismatch detection log) concerning the result, stores it in the database 27 (FIG. 3) (S19) and then proceeds to step S22.

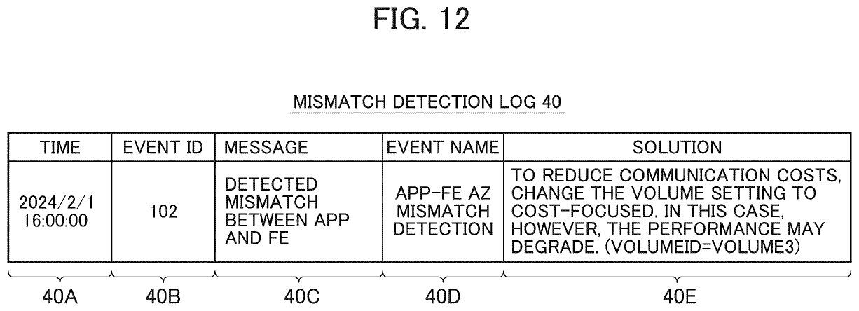

FIG. 12 illustrates the configuration of the mismatch detection log generated at step S19. A mismatch detection log 40 includes a time field 40A, an event ID field 40B, a message field 40C, an event name field 40D, and a solution field 40E.

The time field 40A stores the time when the mismatch detection log 40 was generated, and the event ID field 40B stores the identification information uniquely given to the mismatch detection log 40.

The message field 40C stores a message indicating that the current availability zone match/mismatch detection process detects the application 7 transmitting an I/O request to the front-end portion 20 existing in a different availability zone AZ.

The event name field 40D stores the event name “APP-FE AZ MISMATCH DETECTION” of the event that detects the application 7 transmitting an I/O request to the front-end portion 20 existing in a different availability zone AZ.

The solution field 40E stores a solution to the problem of increased communication costs occurring when there is a mismatch between the availability zone AZ where the application 7 having issued the I/O request exists and the availability zone AZ where the front-end portion 20 as the transmission destination of the I/O request exists.

The mismatch detection log 40 can be read from the storage node 3 by accessing the storage node 3 through the use of a computer device such as a user terminal, and the contents can be displayed on the computer device. The user can confirm the existence of the application 7 transmitting an I/O request to the storage node 3 in a different availability zone AZ or a solution to suppress an increase in communication costs caused by such a state.

If the result from the determination at step S18 is positive, the availability zone detection portion 23A performs an I/O path correction process that notifies the target application 7 of the storage node 3 that is placed in the same availability zone AZ as the target application 7 and is identified as the transmission destination of the I/O request for the I/O-targeted logical volume VOL (S20).

The availability zone detection portion 23A generates a log (hereinafter referred to as an I/O path correction log) indicating that the I/O path correction process has been performed, stores it in the database 27 (FIG. 3) (S21), and then proceeds to step S22.

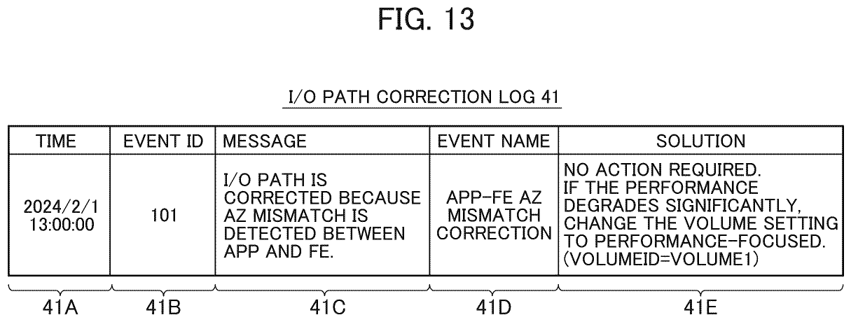

FIG. 13 illustrates the configuration of the I/O path correction log generated at step S21. Similar to the mismatch detection log 40 described above by referencing FIG. 12, the I/O path correction log 41 also includes a time field 41A, an event ID field 41B, a message field 41C, an event name field 41D, and a solution field 41E.

The time field 41A stores the time when the I/O path correction log 41 was generated, and the event ID field 41B stores identification information uniquely given to the I/O path correction log 41.

The message field 41C stores a message indicating that the current availability zone match/mismatch detection process detects the application 7 transmitting an I/O request to the front-end portion 20 existing in a different availability zone AZ.

The event name field 41D stores the event name “APP-FE AZ MISMATCH CORRECTED” of the event that corrected the mismatch between the availability zone AZ where the application 7 having issued the I/O request exists and the availability zone AZ where the front-end portion 20 as the transmission destination of the I/O request exists.

The solution field 41E stores the solution to the problem of degraded I/O performance occurring as a result of correcting a mismatch between the availability zone AZ where the application 7 having issued the I/O request exists and the availability zone AZ where the front-end portion 20 as the transmission destination of the I/O request exists.

The I/O path correction log 41 can be read from the storage node 3 by accessing the storage node 3 through the use of a computer device such as a user terminal, and the contents can be displayed on the computer device. The user can confirm the solution to the degraded I/O performance due to the correction of the I/O path.

Returning to the explanation of FIG. 11B, the availability zone detection portion 23A then determines whether the process at steps S11 through S21 is completed for all records in the I/O path history table 30 (S22).

If the result from this determination is negative, the availability zone detection portion 23A returns to step S10 and then repeats the process at steps S10 through S22 while sequentially selecting other records at step S10 that remain unprocessed at step S11 and later.

If the result at step S22 is positive after completion of the process at steps S11 through S21 for all records in the I/O path history table 30, the availability zone detection portion 23A terminates the availability zone match/mismatch detection process.

### (3-3) I/O Path Correction Process

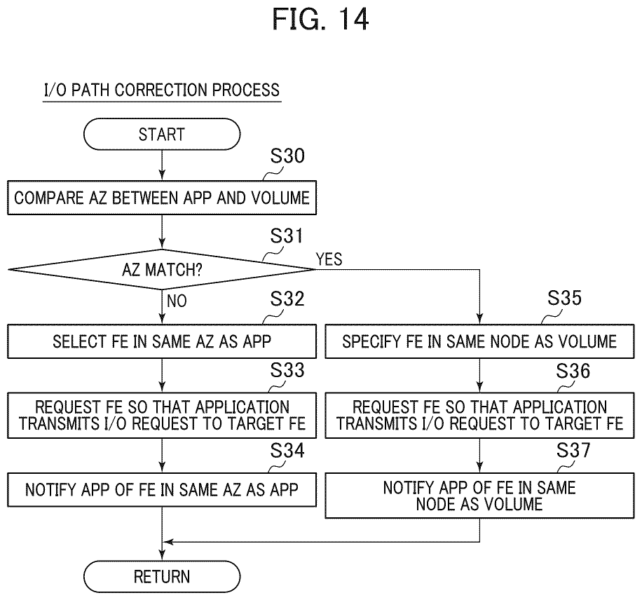

FIG. 14 illustrates the specific processing content of the I/O path correction process performed by the availability zone detection portion 23A at step S20 of the availability zone match/mismatch detection process described above by referencing FIGS. 11A and 11B.

The availability zone detection portion 23A proceeds to step S20 of the availability zone match/mismatch detection process and starts the I/O path correction process illustrated in FIG. 14. The availability zone detection portion 23A compares the availability zone AZ where the target application 7 exists with the availability zone AZ where the I/O-targeted logical volume VOL exists (S30).

Specifically, the availability zone detection portion 23A references the I/O path history table 30 (FIG. 4) and acquires the UUID of the I/O-targeted logical volume VOL. Specifically, the availability zone detection portion 23A identifies a record that is included in the logical volume management table 34 (FIG. 8) and corresponds to the UUID column 34A storing the thus acquired UUID of the I/O-targeted logical volume VOL, thus acquiring the UUID of the storage control portion 21 stored in the storage control portion column 34B of that record.

The availability zone detection portion 23A identifies a record that is included in the storage control portion management table 35 (FIG. 9) and corresponds to the UUID column 35A storing the thus acquired UUID of the storage control portion 21, thus acquiring the UUID of the storage node 3 stored in the storage node column 35B of that record.

The availability zone detection portion 23A identifies a record that is included in the storage node management table 32 (FIG. 6) and corresponds to the UUID column 32A storing the thus acquired UUID of the storage node 3, thus acquiring the availability zone number stored in the belonging-to availability zone column 32B of that record. The acquired availability zone number corresponds to the availability zone AZ where the I/O-targeted logical volume VOL exists.

The availability zone detection portion 23A compares the availability zone number of the availability zone AZ where the thus acquired I/O-targeted logical volume VOL exists with the availability zone number of the availability zone AZ that is acquired at step S14 of the availability zone match/mismatch detection process and allows the target application 7 to exist.

As a result of the comparison at step S30, the availability zone detection portion 23A determines whether the availability zone AZ where the target application 7 exists matches the availability zone AZ where the I/O-targeted logical volume VOL exists (S31).

A negative result from this determination signifies that the target application 7 and the I/O-targeted logical volume VOL exist in different availability zones AZ. The availability zone detection portion 23A selects one front-end portion 20 existing in the same availability zone AZ as the target application 7 and acquires the UUID of the front-end portion 20 (S32).

Specifically, the availability zone detection portion 23A references the storage node management table 32 and selects any one of storage nodes 3 placed in the same availability zone AZ as the target application 7.

The availability zone detection portion 23A selects one of the records in the front-end portion management table 31 (FIG. 5) corresponding to the storage node column 31B storing the UUID of the storage node 3 selected as above and acquires the UUID stored in the UUID column 31A of that record.

The availability zone detection portion 23A requests its own front-end portion 20 to transmit a notification to the target application 7 that the transmission destination of subsequent I/O requests for the I/O-targeted logical volume VOL should be changed to the front-end portion 20 of the UUID acquired at step S32 (S33).

The front-end portion 20 receives this request and transmits a notification to the target application 7 that the transmission destination of subsequent I/O requests for the I/O-targeted logical volume VOL should be changed to the front-end portion 20 assigned with the UUID selected by the availability zone detection portion 23A at step S32 (S34).

The target application 7 receives this notification and changes the setting of the initiator 8 so that the transmission destination of subsequent I/O requests for the I/O-targeted logical volume VOL is changed to the front-end portion 20 assigned with the UUID notified at step S34.

The I/O path correction process then terminates. The availability zone detection portion 23A returns to the availability zone match/mismatch detection process.

A positive result from the determination at step S31 signifies that the target application 7 and the I/O-targeted logical volume VOL exist in the same availability zone AZ. At this time, the availability zone detection portion 23A identifies the front-end portion 20 placed in the storage node 3 including the I/O-targeted logical volume VOL (S35).

Specifically, the availability zone detection portion 23A identifies a record in the front-end portion management table 31 (FIG. 5) corresponding to the storage node column 31B storing the UUID of the storage node 3 acquired in the above-described process at step S30 and reads the UUID of the front-end portion 20 stored in the UUID column 31A of that record.

The availability zone detection portion 23A requests its own front-end portion 20 to transmit a notification to the target application 7 that the transmission destination of subsequent I/O requests for the I/O-targeted logical volume VOL should be changed to the front-end portion 20 assigned with the UUID acquired at step S35 (S36).

The front-end portion 20 receives this request and transmits a notification to the target application 7 that the transmission destination of subsequent I/O requests for the I/O-targeted logical volume VOL should be changed to the front-end portion 20 assigned with the UUID selected by the availability zone detection portion 23A at step S35 (S37).

The target application 7 receives this notification and changes the setting of the initiator 8 so that the transmission destination of subsequent I/O requests for the I/O-targeted logical volume VOL is changed to the front-end portion 20 assigned with the UUID notified at step S36.

The I/O path correction process then terminates. The availability zone detection portion 23A returns to the availability zone match/mismatch detection process.

### (4) Effects of Present Embodiment

In the information processing system 1 according to the present embodiment as above, the availability zone detection portion 23A of the cluster control portion 23 determines whether the availability zone AZ where the application 7 having hitherto issued each I/O request exists matches the availability zone where the I/O destination logical volume VOL exists, based on the I/O path history information stored in the I/O path history table 30.

If these availability zones AZ mismatch, the availability zone detection portion 23A gives notice of the storage node 3 placed in the same availability zone AZ as the availability zone AZ where the application 7 exists, as the transmission destination of subsequent I/O requests, namely, the I/O destination logical volume VOL as the I/O destination.

The information processing system 1 can prevent user data from being directly transferred from the application 7 to the storage node 3 including the I/O destination logical volume VOL across availability zones AZ or prevent user data read from the I/O destination logical volume VOL in response to an I/O request from being directly transferred to the application 7 across availability zones AZ.

In the information processing system 1, the compression necessity determination portion 20A of the front-end portion 20 determines whether data compression is necessary and, if it is determined that the user data read from or written to the I/O destination logical volume VOL for the I/O request needs to be compressed, compresses the user data when it is transferred across availability zones AZ.

When the key focus on the I/O destination logical volume VOL is “cost,” the information processing system 1 can suppress the amount of user data transferred between availability zones AZ, suppress the communication fee generated according to the amount of transferred data, and therefore suppress an increase in operational costs.

### (5) Other Embodiment

The above embodiment has described that the availability zone detection portion 23A of the primary storage node 3 performs the availability zone match/mismatch detection process described using FIG. 11A and FIG. 11B and the I/O path correction process described using FIG. 14. However, the present invention is not limited thereto. It may be favorable to provide an information processing device that performs the availability zone match/mismatch detection process and the I/O path correction process separately from the storage node 3 without providing the availability zone detection portion 23A in the cluster control portion 23 of the storage node 3.

The above embodiment has described the case where the application 7 having issued an I/O request for a certain logical volume VOL as the I/O destination is notified of any storage node 3 placed in the same availability zone AZ as the availability zone AZ where the application 7 exists, as the transmission destination of subsequent I/O requests for the logical volume VOL as the I/O destination. However, the present invention is not limited thereto. It may be favorable to give notice of the storage node 3 that satisfies a specific condition such as giving notice of the storage node 3 with the least load among the storage nodes 3 placed in the same availability zone AZ as the availability zone AZ where the application 7 exists.

### Industrial Applicability

The present invention can be applied to an information processing system including multiple storage nodes placed in different availability zones, for example.

What is claimed is:

1. An information processing system comprising:
a plurality of storage nodes placed in different availability zones,
wherein the storage node includes
a front-end portion that receives an I/O request transmitted from a host node, identifies the storage node including a logical volume as the I/O destination of the received I/O request, and, when the logical volume is placed in the other storage node, transfers the I/O request to the storage node including the logical volume; and
an availability zone detection portion that detects the availability zone to place the host node as the transmission origin of the I/O request;
wherein the front-end portion compresses and transfers user data to be transferred to the storage node placed in the other availability zone, and
wherein the availability zone detection portion compares the availability zone to place the detected host node with the availability zone to place the storage node installed with the availability zone detection portion and, when the availability zone to place the host node does not match the availability zone where the storage node installed with the availability zone detection portion exists, performs a detection process to notify the host node of the storage node placed in the same availability zone as the host node, as the transmission destination of the subsequent I/O requests for the logical volume as the I/O destination.

2. The information processing system according to claim 1,
wherein each of the host nodes and each of the storage nodes are connected via a network,
wherein a management node is further included to manage an address of each of the host nodes on the network and the availability zone to place the host node, and
wherein the availability zone detection portion detects the availability zone to place the host node by specifying an address, on the network, of the transmission origin of the I/O request received by the front-end portion and inquiring of the management node about the availability zone to place the host node as the transmission origin of the I/O request.

3. The information processing system according to claim 1,
wherein each of the logical volumes is assigned with a key focus on whether to focus cost or I/O performance, and
wherein, when the key focus of cost is assigned to the logical volume as the I/O destination of the user data, the front-end portion compresses and transfers the user data between the availability zones and, when the key focus of performance is assigned to the logical volume as the I/O destination of the user data, transfers the user data between the availability zones without compression.

4. The information processing system according to claim 1,
wherein the availability zone detection portion performs the detection process asynchronously with processes of the front-end portion.

5. The information processing system according to claim 1,
wherein the availability zone detection portion generates and stores a log including information on a result of comparison between the availability zone to place the host node and the availability zone to place the storage node where the availability zone detection portion is placed.

6. An information processing method performed by an information processing system including a plurality of storage nodes placed in different availability zones, comprising:
a first step in which the storage node receives an I/O request transmitted from a host node, identifies the storage node including a logical volume as the I/O destination of the received I/O request, and, when the logical volume is placed in the other storage node, transfers the I/O request to the storage node including the logical volume; and
a second step in which the storage node detects the availability zone to place the host node as the transmission origin of the I/O request,
wherein, in the first step, the storage node compresses and transfers user data to be transferred to the storage node placed in the other availability zone, and
wherein, in the second step, the storage node compares the availability zone to place the detected host node with the availability zone to place the storage node and, when the availability zone to place the host node does not match the availability zone to place the storage node, performs a detection process to notify the host node of the storage node placed in the same availability zone as the host node, as the transmission destination of the subsequent I/O requests for the logical volume as the I/O destination.

7. The information processing method according to claim 6,
wherein each of the host nodes and each of the storage nodes are connected via a network in the information processing system,
wherein a management node is further included to manage an address of each of the host nodes on the network and the availability zone to place the host node, and
wherein, in the second step, the storage node detects the availability zone to place the host node by specifying an address, on the network, of the transmission origin of the received I/O request and inquiring of the management node about the availability zone to place the host node as the transmission origin of the I/O request.

8. The information processing method according to claim 6,
wherein each of the logical volumes is assigned with a key focus on whether to focus cost or I/O performance, and
wherein, in the first step, when the key focus of cost is assigned to the logical volume as the I/O destination of the user data, the storage node compresses and transfers the user data between the availability zones and, when the key focus of performance is assigned to the logical volume as the I/O destination of the user data, transfers the user data between the availability zones without compression.

9. The information processing method according to claim 6,
wherein the storage node performs processes in the first step asynchronously with processes in the second step.

10. The information processing method according to claim 6,
wherein, in the second step, the storage node generates and stores a log including information on a result of comparison between the availability zone to place the host node and the availability zone to place the storage node.
